(19) United States
(12) Patent Application Publication
(10) Pub. No.: US 2018/0236959 A1
(43) Pub. Date: Aug. 23, 2018

(54) VEHICULAR ANGLE ALERT AND SAFETY SYSTEM AND METHOD

(71) Applicant: SCHROTH SAFETY PRODUCTS LLC, Pompano Beach, FL (US)

(72) Inventor: Ray Garcia, Boca Raton, FL (US)

(73) Assignee: SCHROTH SAFETY PRODUCTS LLC, POMPANO BEACH, FL (US)

(21) Appl. No.: 15/753,220

(22) PCT Filed: Aug. 19, 2016
(86) PCT No.: PCT/US2016/047795

§ 371 Date: Feb. 16, 2018

Related U.S. Application Data
(60) Provisional application No. 62/207,698, filed on Aug. 20, 2015.

(51) Int. Cl. B60R 21/0132; G08B 21/02; B60Q 9/00

(52) U.S. Cl. CPC B60R 21/0132; B60R 2021/0018; B60Q 9/00; G08B 21/02

(57) ABSTRACT

The invention consists of various embodiments of a system that uses electromechanical means to alert a vehicle operator of an imminent vehicle roll-over and protect the operator in a roll-over event. The system uses an electronics control unit (ECU) that is able to detect the deflection angle of the vehicle's tilt with the horizontal. If this angle exceeds a certain amount, the operator is alerted of the increased risk of roll-over via haptic feedback whereby the ECU controls a seatbelt electromechanical system to create a haptic feedback alert to the operator. If the angle exceeds a second higher amount, the system braces the operator for a roll-over event by tightening the seatbelt, thereby better protecting the operator. The fact that the system is electromechanical, instead of pyrotechnical, makes the system reusable. Another embodiment of the invention comprises a safety process used by the ECU to alert and protect the operator. By conducting this procedure, the ECU is able to detect when a critical angle has been exceeded by the vehicle and what response is appropriate for the circumstance.

### CROSS-REFERENCE TO RELATED APPLICATIONS

This U.S. Non-Provisional Patent Application is a National Stage Entry of, and claims the benefit of, PCT Application No. PCT/US16/47795, filed on Aug. 19, 2016, which claims priority from U.S. Provisional Patent Application No. 62/207,698, filed on Aug. 20, 2015 (now expired); and is incorporated by reference as if fully set forth herein.

### FIELD OF THE INVENTION

This invention relates generally to the field of vehicle safety, and more particularly, to a vehicular angle alert and safety system and integrated method.

### BACKGROUND

Roll-over accidents cause a substantial number of injuries and deaths every year. Particularly in utility and work vehicles that are used in dangerous locations, the risk of rolling-over the vehicle adds to the already heightened level of risk for work-related injury. Examples of such danger-prone vehicles are the various mining vehicles that are often operated in open mines where they have to navigate tight, unpaved roads up and down the sides of the open mine. The bulky and heavy design of these vehicles makes their operation relatively dangerous, especially on such narrow and unpaved passages. Furthermore, the center of gravity of many of these vehicles is very high due to the manner with which they transport their payload, thus increasing the risk of a vehicular roll-over. In order to avoid such accidents, operators are trained to look out for terrain risks while conducting their driving duties; however, this practice sometimes falls short due to human error and terrain risks that are not obvious to the operator.

Some safety solutions have been utilized to alert the operator or to protect the operator during the roll-over. Some systems, as may be known in the art, utilize a pyrotechnic, triggered and mechanically placed, so that it tightens and locks the operator's seatbelt upon detection of a roll-over. These systems, however, are reactive to the incident. As such, they help to prevent injury to the operator in a roll-over event, but they do not operate in such a way as to prevent the event from occurring in the first place. Furthermore, due to the exhaustive nature of the pyrotechnics utilized in these types of safety systems, the systems can only be used once and must be replaced after use.

It would therefore be desirable to have a reusable safety system that is integrated with the seatbelt of the operator so that the safety system is able to both alert the operator of an unsafe vehicle angular orientation and better protect the operator in the event of a roll-over.

It would also be desirable to have an integrated method with which the reusable safety system operates in order to assist the operator in preventing roll-overs while remaining ready to protect the operator in the event of a roll-over.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY

The present invention is directed to a roll-over avoidance system and integrated method for vehicles that alerts the driver or operator as the vehicle's risk of rolling-over increases and protects the operator upon the event of such a roll-over.

With respect to the system, embodiments thereof provide for a roll-over avoidance and protection system comprising the following components: a tilt or orientation sensor capable of detecting angle of orientation, an electronic control unit (ECU), a power source, and an electromechanical system, operatively coupled to the operator's seatbelt. The tilt or orientation sensor, power source, and electromechanical system are all electrically connected to the ECU.

Embodiments of the ECU are configured to receive tilt/angle measurements from the tilt and/or orientation sensor, which is operatively coupled to the vehicle. When the vehicle tilts beyond a first critical angle (a certain set angle with respect to the vertical or horizontal), the tilt and/or orientation sensor detects this event and communicates it to the ECU. Upon receiving notice of the first critical angle, the ECU alerts the driver or operator by the use of a haptic feedback means. Preferred embodiments of said haptic feedback means include sequential tugging of the operator's seatbelt, by electromechanical means, in order to alert the operator of the dangerous angle of the vehicle and increased risk of rolling over.

The haptic feedback means continues until the vehicle's orientation is returned to an angle below the first critical angle or until the vehicle's angle reaches a second critical angle, which exceeds the first critical angle. The second critical angle is calculated to be the angle by which the vehicle is in danger of rolling over or in the process of rolling over. If the system detects the second critical angle, the operator's seatbelt automatically tightens, and remains tight, by electromechanical means.

Other embodiments of the ECU may further comprise additional means to determine orientation and calculate tilt/angle measurements so as to remove the need for a separate or external orientation sensor.

Other embodiments of the system may further comprise a buckle switch that may be utilized in order to activate or deactivate the system when the operator is fastened to the seat or when the operator is not, respectively.

Embodiments of the present invention may also comprise an integrated method of operation whereby during the operation of the vehicle, the system is concurrently detecting the angle of orientation of the vehicle with respect to the horizontal or vertical. Once the vehicle's orientation is detected to exceed a certain first critical angle, in any direction, the system will alert the operator with the use of a haptic feedback means. The haptic feedback would serve as a warning, thus giving the operator a chance to correct the vehicle and return it to a safe, level-orientation. However, if the system detects that the vehicle's orientation exceeds said first critical angle and further exceeds the second critical angle, wherein said second critical angle is higher than the first critical angle, the system will brace the operator for a roll-over event by tightening the seatbelt. In this embodiment, the system is, therefore, continuously measuring the tilt angle of the vehicle in order to provide the proper response for the given vehicle tilt angle.

Certain embodiments of the present invention may be used for, but not limited to, vehicle safety beyond mining applications, such as vehicles in commercial, military, police, ambulatory, off-roading, sports, and recreational applications.

Other embodiments of the present invention may be used for, but not limited to, vehicle safety beyond road-based vehicles, such as boats or other forms of watercraft.

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a system diagram in accordance with an embodiment of the present invention showing a vehicle angle alert and safety system;

FIG. 2 is a system diagram in accordance with another embodiment of the present invention showing a vehicle angle alert and safety system; and

FIG. 3 is a process flowchart in accordance with another embodiment of the present invention showing a vehicle angle alert and safety process.

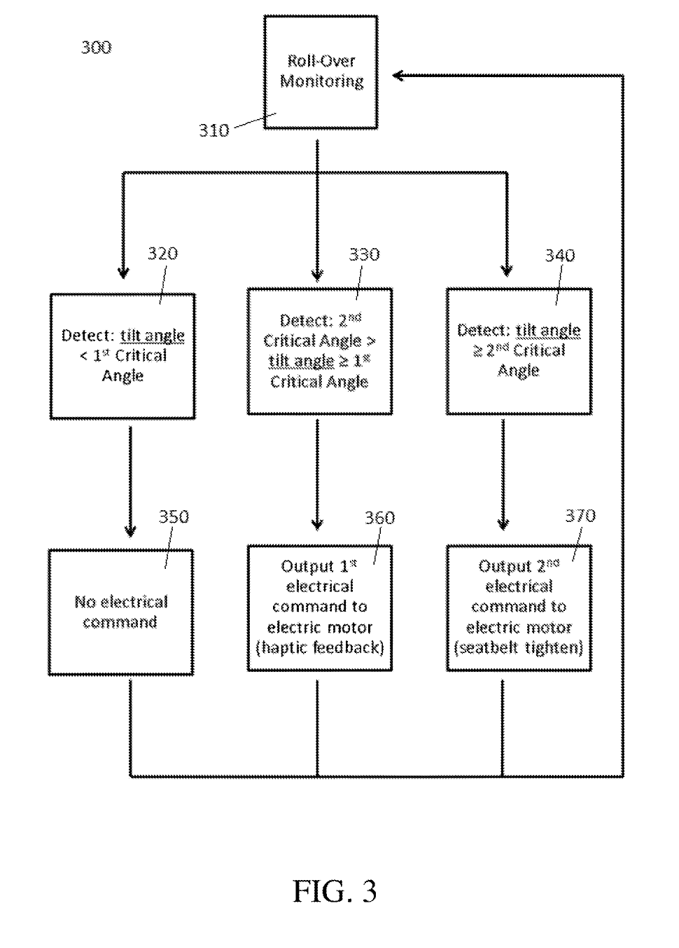

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C but also one or more other components or structures.

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The term “electromechanical system” is synonymous with the term “motorized seatbelt” or “MSB” and refers to a system that comprises at least one electromechanical component and a seatbelt.

While this specification concludes with claims defining the features of embodiments of the invention that are regarded as novel, it is believed that the invention will be better understood from a consideration of the following description in conjunction with the figures, in which like reference numerals are carried forward.

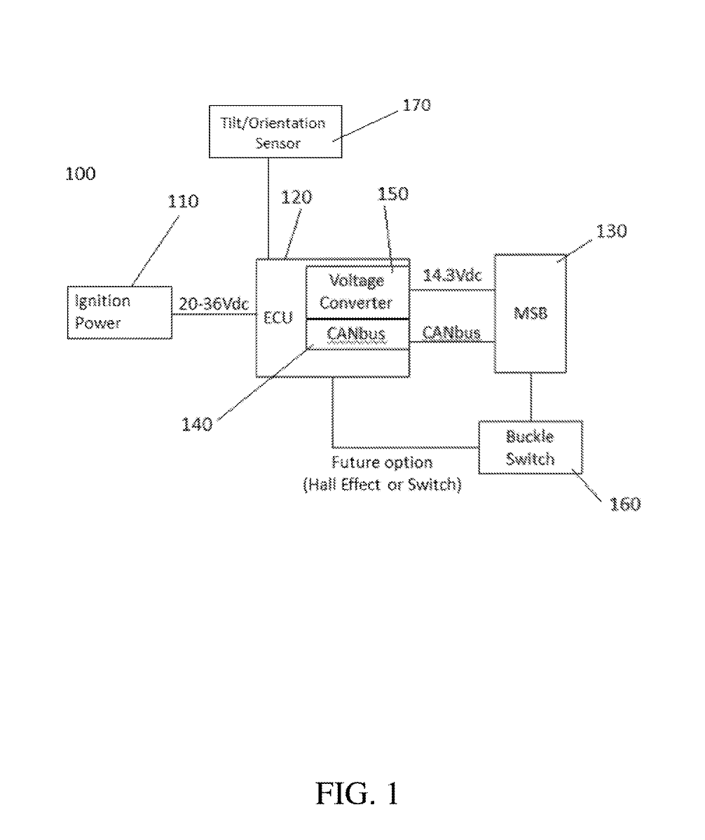

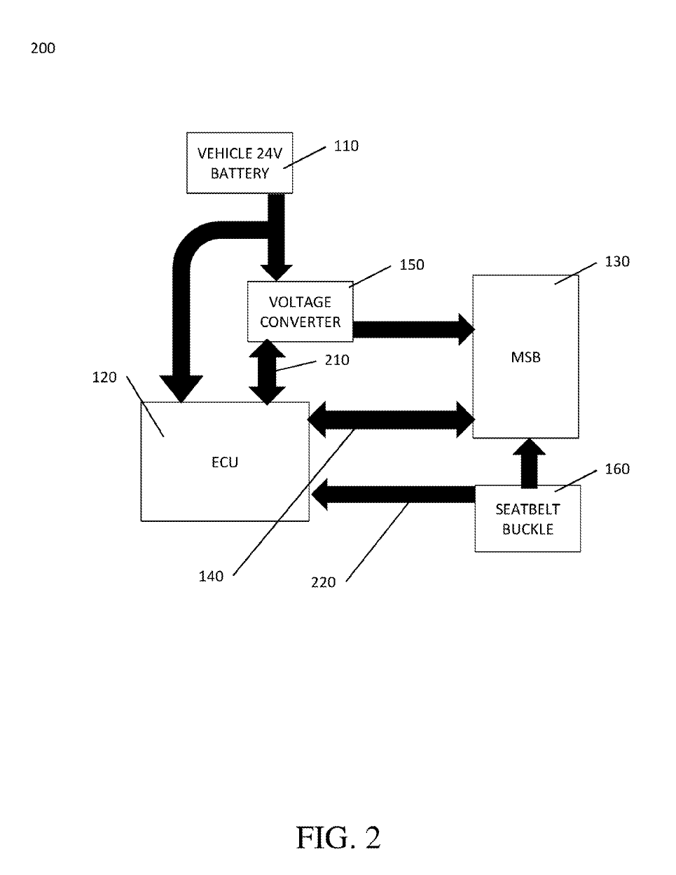

Referring to FIGS. 1 and 2, an embodiment of the present invention is a roll-over warning and safety system 100, which is made up of the following components: a tilt or orientation sensor 170 capable of detecting angle of orientation, an electronic control unit (ECU) 120, a power source 110, and an electromechanical system 130, which is operatively coupled to the operator's seatbelt. The components relate to each other as follows: the orientation sensor 170, power source 110, and electromechanical system 130 are all electrically connected to the ECU 120 so as to receive power, receive environmental inputs, output signals, etc.

In the embodiment shown in FIG. 1, the ECU 120 is electrically connected to the vehicle's electrical system. This electrical system acts as the power source 110 for the ECU 120 and, via the ECU 120, powers the other components of the system 100. One skilled in the art, however, will appreciate that the power source 110 can be accomplished using a variety of power source means, such power source means may include, but not limited to, a separate power source isolated from the vehicle's electrical system, a portable power source, or other means of delivering electrical power to the system. Furthermore, depending on the voltage with which the ECU 120 functions, a voltage converter 150 may be needed in order to convert the voltage output from the electrical system or power source 110 to a voltage level that is within the acceptable range of the ECU 120. The voltage converter 150 may be integrated in the ECU 120 as in system 100 in FIG. 1 or separate from the ECU 120 as in system 200 in FIG. 2. The orientation sensor 170 is fixed to the vehicle in such a manner so as to effectively read the vehicle's tilt orientation or angular deflection from the horizontal. The orientation sensor 170 may be in the form of a means that includes, but is not limited to, the use of: gyroscopes, Hall voltage sensors, rotary variable differential transformers, piezo-electric transducers, potentiometers, rotary encoders, string potentiometers, or fluid level measurement. The ECU 120 receives data regarding the tilt or angular deflection from the orientation sensor 170 and compares this data to a pre-programed, or user-set, first critical angle and second critical angle. Depending on the angle measurement in relation to the first critical and second critical angles, the ECU 120 will either send a command to the electromechanical system 130 or refrain from doing so. It is contemplated that the orientation sensor 170 and ECU 120 can be capable of detecting and processing any number of critical angles and sending a prescribed command to the electromechanical system 130 for the instance that those angles are detected. The communication between the ECU 120 and the electromechanical system 130 may be done by various means, but is preferably by means of a CANbus 140 (Controller Area Network bus) connection. Other anticipated means of communication between such system components may include, but are not limited to, conventional electrical wiring, fiber optics, wireless communication, or other means known in the art. In one embodiment, the electromechanical system 130 is in the form of an electromotor that is physically connected to the operator's seatbelt in such a manner as to allow for the electromotor to loosen or tighten the seatbelt. The electromotor can be of a variety of electromechanical devices such as, but not limited to, a stepping motor, servo, electrically-controlled pneumatics, electrically-controlled hydraulics, or any other conventional method of creating a physical response with an electronic command.

Alternate embodiments of the system include a system where the tilt or orientation sensor 170 is incorporated in the hardware of the ECU 120. In such a case, the orientation sensor 170 will not be a separate component of the system, but will rather be replaced by a functional capability of the ECU 120 thus eliminating the need for installation of the separate component, as is shown in FIGS. 1 and 2. It should be noted, however, that if the ECU 120 is to detect angle deflection, it will necessitate installment onto the vehicle in a manner that accurate readings of the vehicle's tilt or angular orientation may be taken.

Embodiments may also further comprise a buckle switch 160 that may be in the form of a seatbelt latch whereby the operator's action of buckling his seatbelt completes the electrical connection between the ECU 120 and the electromechanical system 130. Completing the electrical connection between the ECU 120 and the electromechanical system 130 activates the electromechanical system 130 so that the operator may automatically engage the vehicular angle alert and safety system 100 when the seatbelt is in use and disengage the system when the seatbelt is not in use. Alternatively, the buckle switch 160 may just have a digital input 220 which communicates to the ECU 120 whether the operator is fastened to the seatbelt so that the ECU 120 may activate the electromechanical system 130.

A further embodiment of the present invention is in the form of a method 300 utilized by the ECU 120 in detecting critical angles, alerting the operator, and bracing the operator in the case of a roll-over event. The method 300 comprises the following steps: monitoring tilt angle of vehicle 310; detecting a tilt angle at or above a first critical angle 330; and outputting a first electrical command to an electrical motor 360, wherein said first command prompts said electrical motor to tighten and loosen a seatbelt in a sequential manner. This sequential tightening and loosening is commonly referred to as haptic-feedback and is meant to alert the operator of risk of a dangerous event, which in this case is a vehicle roll-over. The ECU then continuously monitors the tilt angle of the vehicle 310 for changes in angle. This haptic feedback will continue for the duration that the vehicle remains in this angular orientation.

If the operator adjusts the vehicle's tilt to a safe position, below the first critical angle, the following steps are performed: monitoring tilt angle of vehicle 310; detecting a second orientation angle below said first critical angle 320; and stopping said output of said first electrical command 350. By stopping the output of the first electrical command, the haptic feedback is effectively stopped. The ECU then continuously monitors the tilt angle of the vehicle 310 for changes in angle.

However, if the tilt or deflection from the horizontal increases to a dangerous level, at or beyond a second critical angle, the following steps are performed: monitoring tilt angle of vehicle 310; detecting a second orientation angle at or above a second critical angle 340; and outputting a second electrical command to said electric motor 370, wherein said second electrical command prompts said electric motor to tighten said seatbelt into a locked position. The ECU then continuously monitors the tilt angle of the vehicle 310 for changes in angle.

If the operator is able to return the vehicle to a tilt angle below the second critical angle, the ECU 120 performs the following steps: monitoring tilt angle of vehicle 310; detecting a third orientation angle below said second critical angle and at or above said first critical angle 330; and outputting said first electrical command to said electrical motor 360. This will return the system's response from bracing the operator for a roll-over to the haptic feedback alert. The ECU then continuously monitors the tilt angle of the vehicle 310 for changes in angle.

If the operator returns the vehicle's tilt to a safe position, below the first critical angle, the following steps are performed: monitoring tilt angle of vehicle 310; detecting a fourth orientation angle below said first critical angle 320; and stopping said output of said first electrical command 350. This would stop the output of the first electrical command, thus stopping the haptic feedback.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

What is claimed is:

1. A vehicle safety system, the system comprising:
a means for detecting angle of orientation;
an electronic control unit (ECU), electrically connected to said means for detecting angle of orientation;
a power source, electrically connected to said ECU;
an electric motor, electrically connected to said ECU; and
a seatbelt, mechanically fixed to said electric motor.

2. The vehicle safety system of claim 1, further comprising a buckle switch, wherein said buckle switch is mechanically fixed to said seatbelt and electrically connected to said ECU.

3. The vehicle safety system of claim 1, further comprising a voltage converter, electrically connected between said ECU and said electric motor.

4. A vehicle safety system, the system comprising:
an electronic control unit (ECU), said ECU capable of angle orientation with respect to horizontal;
a power source, electrically connected to said ECU;
an electric motor, electrically connected to said ECU; and
a seatbelt, mechanically fixed to said electric motor.

5. The vehicle safety system of claim 4, further comprising a buckle switch, wherein said buckle switch is mechanically fixed to said seatbelt and electrically connected to said ECU.

6. The vehicle safety system of claim 4, further comprising a voltage converter, electrically connected between said ECU and said electric motor.

7. A method for vehicle roll-over safety protocol, the steps of which comprising:
detecting an orientation angle at or above a first critical angle; and
outputting a first electrical command to an electrical motor, wherein said first command prompts said electrical motor to tighten and loosen a seatbelt in a sequential manner.

8. The method of claim 7, further comprising the steps of:
detecting a second orientation angle below said first critical angle; and
stopping said output of said first electrical command.

9. The method of claim 7, further comprising the steps of:
detecting a second orientation angle at or above a second critical angle;
stopping said output of said first electrical command; and
outputting a second electrical command to said electric motor, wherein said second electrical command prompts said electric motor to tighten said seatbelt into a locked position.

10. The method of claim 9, further comprising the steps of:
detecting a third orientation angle below said second critical angle and at or above said first critical angle;
stopping said output of said second electrical command; and
outputting said first electrical command to said electrical motor.

11. The method of claim 10, further comprising the steps of:
detecting a fourth orientation angle below said first critical angle; and
stopping said output of said first electrical command.
